(19) United States
(12) Patent Application Publication
(10) Pub. No.: US 2008/0100574 A1
(43) Pub. Date: May 1, 2008

(54) Display cursor control device with enhanced multiple dimensional tilt angle operation

(75) Inventors: Ruey-Der Lou, Hsinchu City (TW); Jung-huang Liao, Jhubei City (TW); Wen-hsiung Yu, Nantou City (TW)

Correspondence Address: Bo-In Lin, 13445 Mandoli Drive, Los Altos Hills, CA, 94022, US

(73) Assignee: IMU Solutions, Inc.

(21) Appl. No.: 11/904,403

(22) Filed: Sep. 26, 2007

Related U.S. Application Data
(60) Provisional application No. 60/855,718, filed on Oct. 30, 2006.

(51) Int. Cl. G06F 3/033

(52) U.S. Cl. 345/163; 345/157

(57) ABSTRACT

A data-handling and processing system includes an image-display cursor-control device for controlling an image display cursor of an image display. The system is further operated a pad for placing and moving the image-display cursor-control device and the pad has a curved surface. The image-display cursor-control device further includes an accelerometer for sensing a tilt angle in moving along the curved surface of the pad. The image-display cursor-control device further includes a container housing for containing the accelerometer therein. The container housing has a curved bottom surface for conveniently tilting the display-cursor control device to change an elevation level of the accelerometer

This Formal Application claims a Priority Date of Oct. 30, 2006 benefited from a Provisional Patent Applications 60/855,718 filed by an Applicant as one of the Inventors of this Application. The disclosures made in Patent Application 60/855,718 are hereby incorporated by reference in this Application.

### BACKGROUND OF THE INVENTION

1. Field of the Invention

This invention relates generally to a display cursor-control device such as a computer mouse for graphic user interface (GUI). More particularly, this invention relates to an improved cursor control device includes an accelerometer configured with a curves shaped bottom surface or a curved shaped pad to enhance a multiple dimensional tilt angle control of a display cursor.

2. Description of the Prior Art

Majority of conventional display cursor-control devices, e.g., computer mouse, is implemented with either optical movement sensing or measurements of the ball rolling movements. Such devices are however limited to operate on a flat surface that requires a certain space for device movement. Furthermore, in order to move the device, health hazards are often caused that includes harm to nerves on the hands, the arms and even more extended parts of the body and cause more serious problems. In order to resolve such problems and limitations, a wide variety of different types of cursor control devices have been disclosed and proposed. However, each of these different types of devices still has limitations and difficulties as further described below.

In order to overcome the limitation of the cursor control devices most commonly used, e.g., the computer mouse, acoustic mouse or cursor control systems implemented with RF signals are implemented. Such devices however require special signal receiving devices installed in a computer either on the keyboard or around a monitor. Such systems are therefore more costly and complicate to implement and do not provide useful and practical solution to replace the conventional computer mouse as a cursor control device.

In different patented inventions, the computer mouse is implemented as a glove such that the cursor control system can be operated when the mouse is lift away from a flat surface and there are no requirements to install signal-receiving devices on the computer. These types of cursor control devices can also be implemented as rings that a user can put on the fingers to control the cursor movements. However, since the operations of these kinds of cursor control devices require entirely different movement and coordination between the movement of hands or fingers with the movements of the cursor, these types of cursor control devices have not been well received in the market.

There are also gyroscopic pointing devices that implement the cursor control system with gyro to move the cursors with mouse orientations. However, such mouse tends to be bulky and heavy. Furthermore, The device is more expensive to implement due to the more complicate gyro systems.

Image pointing control devices implemented with accelerometer are also disclosed in Patent WO0190877 where a cursor may be controlled by tilting the control device to different tilt angles. However, movements of cursor by tilting the mouse to different angles is often more difficult to implement with conventional configuration of computer mouse or other image pointing devices. Specifically, tilting operation of an image point device with flat bottom surface generally requires a supporting structure. Support structure is required because the cursor control is less stable when such device is operated in the mid air. It is therefore necessary to provide a support structure for the computer mouse such that cursor can be controlled with required stability. However, requirement of such supporting structure causes additional inconvenience and complications thus limiting practical application of such computer mouse or image pointing devices.

Therefore, a need still exists in the art of cursor control and pointing systems to provide new and easy to use system compatible with current control and point devices with low production costs such that the above discussed difficulties and limitations can be resolved.

### SUMMARY OF THE PRESENT INVENTION

One aspect of this invention is to provide a cursor control device that can flexibly operate without requiring the device to move along a flat surface. Specifically, a new control device configuration is provided with either a curve bottom surface to enhance the convenience of device tilting movements. Alternately, a device pad with curve surface is provided to provide a tilting angle of the control device when the control device is moved along the curved surface of the device pad. Operation of the mouse along a curved surface pad provides the advantage that the operation of such mouse is generally similar to the operation of a conventional mouse.

More specifically, a cursor control device or a point device pointing to a display image is disclosed that has a curved bottom, e.g., an elliptical shape bottom surface. A user of the device can easily control the movement of a cursor or a display image by conveniently tilting the device in all directions with minimum hand and wrist movements. Such device requires very small surface area on a desk or on any surface for supporting the lowest contact area of the curve bottom surface. It is understood that such surface support may be optional because the cursor can be moved by tilting the control device that can be performed under the condition that the control device is placed on a surface or lift up from a supporting surface without support.

Another aspect of the invention is to provide an improved cursor control device or an image point device with improved signal process of the measurements from an acceleration sensor, i.e., accelerometer, by providing different sensitivities for the acceleration measurements along different angular orientations. Such different sensitivities are implemented to compensate for the differences in freedom of angular movements along different angular orientations of the wrist in tilting the device when the device is support on a surface. Specifically, the acceleration measurements are processed with greater sensitivity in measuring tilt angle along a vertical direction in controlling the up and down of the cursor than the sensitivity of right or left tilt movements in controlling the cursor in moving to the right or left side respectively.

Another aspect of the invention is to provide an improved cursor control device or an image point device with improved signal process of the measurements from an acceleration sensor, i.e., accelerometer, by providing different sensitivities for the acceleration measurements at different movement speed. Specifically, when the cursor is moved at low speed, the sensitivity of acceleration measurement is reduced such that the stability of cursor movement is improved to satisfy a user's demand that higher cursor stability is usually expected when the user is moving the cursor or a pointer at a lower speed.

Another aspect of the invention is to provide an improved cursor control device or an image point device with improved signal process of the measurements from an acceleration sensor, i.e., accelerometer, by providing acceleration measurements of the angular changes along the roll and pitch axes. Furthermore, the control of cursor is implemented with reduced sensitivity when the computer mouse or pointing device is lift up from a supporting surface compared to the measurement sensitivity when the mouse is placed on a supporting surface. The differences of measurement sensitivity is to provide more stable cursor control when the mouse is moved without a supporting surface as the movement of the mouse in the air is more vulnerable to sudden vibrations and shakes of the hand movement. Specifically, it is an aspect of this invention to resolve this potential instability issue in operating and moving a computer mouse in the air, a mouse with a curved bottom surface of a mouse pad with curved surface is provided to generate a tilt movement as the user is moving the control device horizontally along different directions. The curved bottom surface or the mouse pad with a curved surface thus adds to the stability and convenience of mouse operations.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A to 1D are respectively a perspective view, a top view a front view and a side perspective view of a display cursor control device, i.e., a mouse, of the present invention.

FIG. 2 is a perspective view of a mouse pad with a curved surface to allow a user to move a mouse horizontally for generating a tilting angle to move a cursor or a display image-pointing element.

FIG. 3 is a functional block diagram for showing the accelerometer implemented in a cursor control device or a graphic pointing device of this invention.

### DETAILED DESCRIPTION OF THE PREFERRED EMBODIMENT

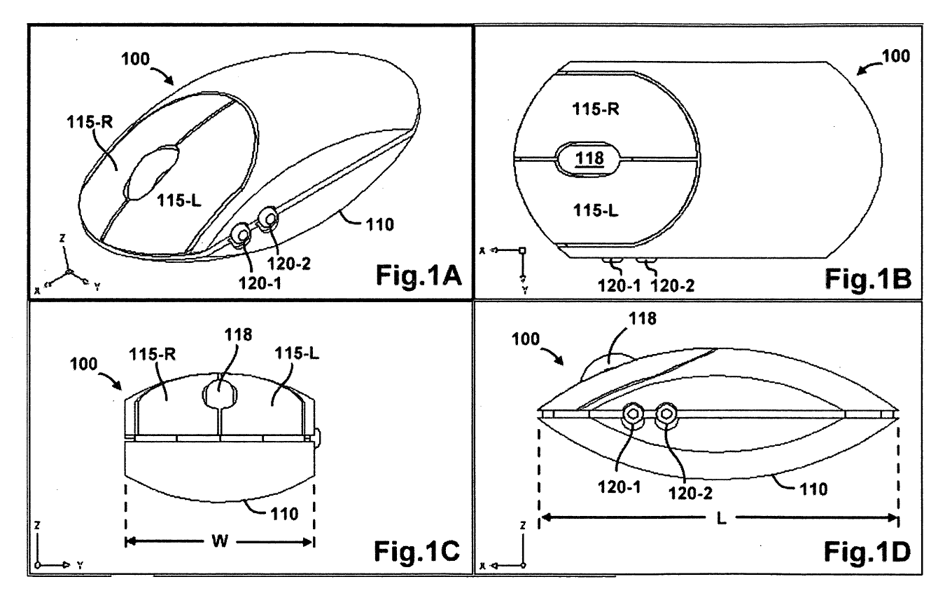

Please refer to FIGS. 1A to 1D for a perspective view, a top view a front view and a side perspective view of a display cursor control device, i.e., a mouse 100 of the present invention. The display-cursor control device 100 has a curved bottom surface 110 to enhance a movement for conveniently changing the tilt angle of the mouse. The display-cursor control device further includes an accelerometer for sensing a level variation of the mouse. The display cursor-control device such as a computer mouse with a curved bottom surface or a curved mouse pad, the mouse can be convenient tilted to different angles when the mouse or the mouse pad is place on a table. Soon as the mouse is moved to a new tilt angle, the accelerometer detects a level change. In response to the level change, a display cursor is moved on a user graphic interface (GUI) device, e.g., a computer monitor. More specifically, the display-cursor control device 100 as shown further has the following design functions.

As shown in FIGS. 1A to 1D, the width is illustrated along the Y-direction and the length is along the X-direction. In order to compensate the degree of movement differences of a human wrist, e.g., when the mouse is placed on a table, the wrist has greater freedom of movements in tilting to the right and left than upward or downward, the mouse 100 is design to have narrower width W and greater length L. The greater length, i.e., L>W, allows a more convenient tilt movement along the X-direction. Furthermore, the accelerometer is design to have greater measurement sensitivity when the mouse has a tilt angle along the X-direction than that along the Y-direction such that better control is achieved for a user in moving the cursor by tilting movements of the mouse. Therefore, a tilt angle relative to the X-axis generates a greater movement of the cursor along a vertical direction compared to a same tilt angle relative to the Y-axis.

In addition to the conventional right and left buttons 115-R, and 115-L and the wheel 118 as that regularly provided in the computer mouse, the mouse of this invention further includes two side buttons 120-1 and 120-2. The button 120-1 is programmed to function as a table-top/mid-air operation-mode button to alternate the operation of the mouse either to operate on the top surface of a table or to operate in the mid-air. The cursor control sensitivity is reduced when the mouse is operated in a mid-air mode. The button 120-1 can be replaced with a weight sensor placed on the bottom surface of the mouse. A weight sensing operation at the bottom surface of the mouse may be employed to alternate the mode of operation between a tabletop operation mode and a mid-air operation mode. The button 120-2 is programmed to function as an active/standby button. When the button 120-2 is pushed to an active mode, the tilt angle of the mouse is applied to control the cursor movement. When the button 120-2 is released (or toggled) to a standby mode, the cursor stays at one location and not moved with the movement of the mouse. The mouse can also provide a dual standby mood to turnoff the mouse when the mouse is idled without movement for a designated period to achieve power savings. It is another option to continuously press down both of the left and right buttons 115-R and 115-L to return the display cursor to the center of the display device.

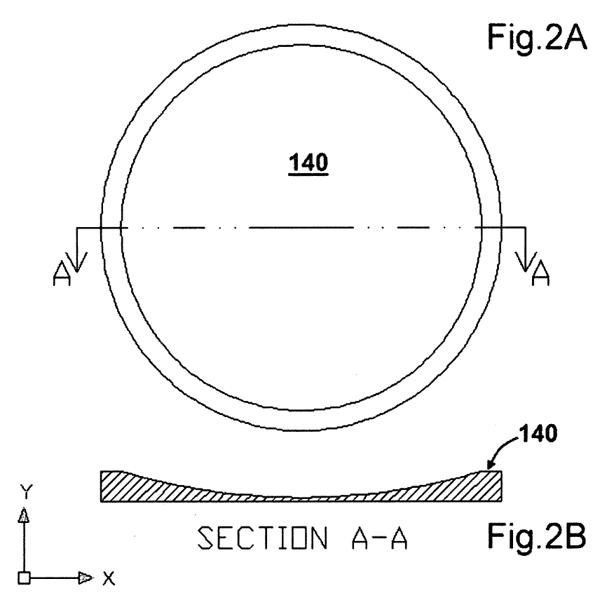

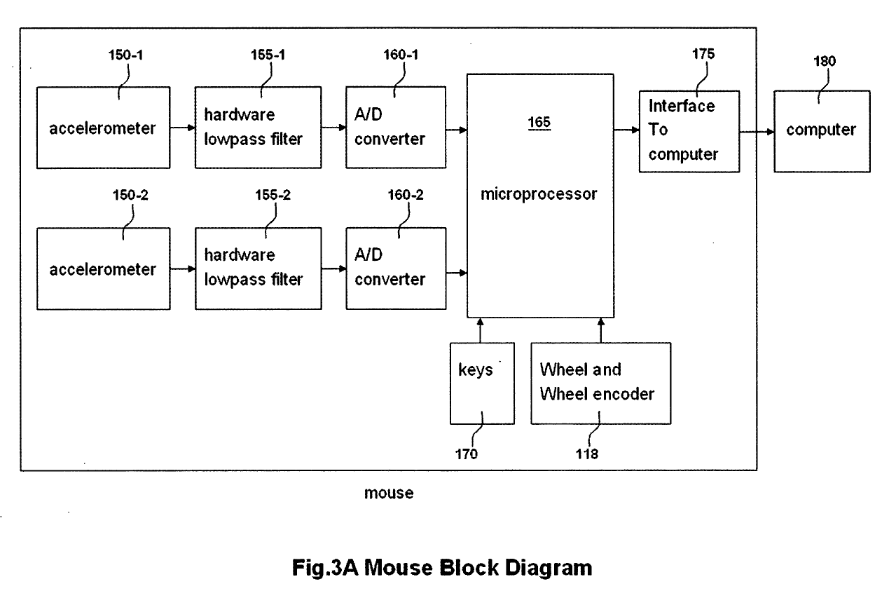

Instead of a mouse with a curved bottom surface discussed above, FIGS. 2A and 2B show an alternate embodiment with a mouse-pad 125 that has a curved surface is shown. As a user moves the mouse on the mouse pad 125, a tilt angle is generated and a cursor movement is created.

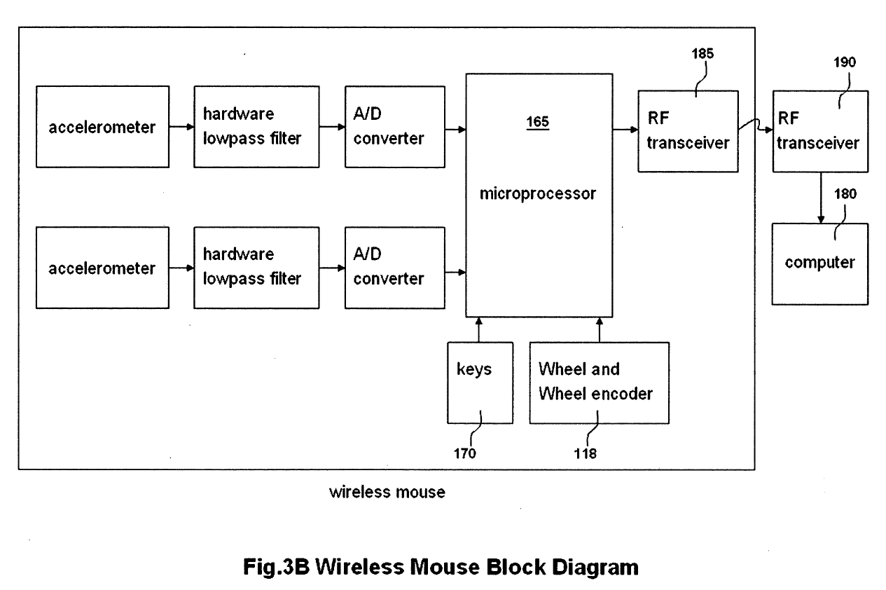

FIG. 3A shows a functional block diagram of a cursor movement control device such as a computer mouse that controls the movements of a cursor by sensing the angular tilt motions of a mouse implemented with two accelerometers. The cursor-movement control device includes a first accelerometer 150-1 and a second accelerometer 150-2 for detecting accelerations along two directions, e.g., acceleration along the X-direction and the Y-direction. The detected acceleration signals are transmitted to a first and a second low-pass filter 155-1 and 155-2 respectively to filter out some high frequency noises. The filtered signals are transmitted to a first and a second analog to digital converters (ADC) 160-1 and 160-2 to covert the analog signals to digital signals for inputting to a microprocessor 165. The microprocessor 165 also receives input signals from the keys 170 on the mouse, e.g., the signals generated from buttons 115-R, 115-L, 120-1 and 120-2. The microprocessor 165 further receives signals from the wheel 118 and wheel encoder for processing signals generated from the motion of the wheel 118. The microprocessor 165 carries signal processes as will be further described below to generate signals outputting to a computer 180 through a computer interface 175. The computer interface 175 typically generates a multiple digital data representing a cursor movement corresponding to the tilt angle changes of the mouse detected by the accelerometers 150-1 and 150-2.

FIG. 3B shows a functional block diagram of a wireless mouse that has a similar functional block configuration as the mouse shown in FIG. 3A. The only exception is that the wireless mouse shown in FIG. 3B further includes a RF transmitter 185 for transmitting signals of the movements of the cursor to the computer 180 that further includes a RF receiver 190 to receive the signals transmitted from the RF transmitter 185.

The microprocessor 165 carries out several functions in processing the digital data received from the analog-to-digital converter. For the purpose of controlling the display cursor of the computer 180, an initialization process is carried out to initialize various parameters. After the initialization process, the microprocessor carries out a major task as a low pass filter to process the digital data according to anticipated conditions. There may be different anticipated conditions as listed below: 1) The mouse stay at a stationary position with no movement at all. 2) The mouse moves slowly. 3) The mouse moves at medium speed. 4) The mouse moves at high speed. The digital filter carried out digital signal process functions in anticipation of these conditions based on the detection of measurements from the accelerometers of the mouse movements such that stable and accurate cursor control can be achieved. The details of these data filtering processes are included in another Patent Applications and are hereby incorporated by reference.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An image-display cursor-control device comprising:
a container housing containing an accelerometer therein having a curved bottom surface for conveniently tilting said display cursor control device to change an elevation level of said accelerometer.

2. The image-display cursor-control device of claim 1 further comprising:
a computer mouse having said curved bottom surface for connecting to a computer for conveniently tilting to different angles in moving a cursor on an image display for said computer.

3. The image-display cursor-control device of claim 1 wherein:
said image-display cursor-control device having width represented by W and a length represented by L wherein L>W for allowing more convenient wrist movements.

3. The image-display cursor-control device of claim 1 wherein:
said accelerometer is provided with a higher measurement sensitivity along a width direction than a longitudinal direction of said image-display cursor-control device.

4. The image-display cursor-control device of claim 1 wherein:
said accelerometer is provided with a different measurement sensitivities along different directions of tilt angles of said image-display cursor-control device.

5. The image-display cursor-control device further of claim 1 comprising:
a control button for alternating an operational mode of said image-display cursor-control device.

6. The image-display cursor-control device of claim 1 further comprising:
a control button for alternating an operational mode for operating said image-display cursor-control device in a table-top mode and a mid-air mode.

7. The image-display cursor-control device of claim 1 further comprising:
a control button for alternating an operational mode for operating said image-display cursor-control device in a table-top mode and a mid-air mode and for alternating a measurement sensitivity when operating in said table-top mode and said mid-air mode.

8. The image-display cursor-control device of claim 1 further comprising:
a sensing device disposed on said bottom surface of said image-display cursor-control device for sensing and alternating an operational mode of said image-display cursor-control device in operating in a table-top mode or an mid-air mode.

9. The image-display cursor-control device of claim 1 further comprising:
a sensing device disposed on said bottom surface of said image-display cursor-control device for sensing and alternating an operational mode of said image-display cursor-control device in operating in a table-top mode or an mid-air mode and for alternating a measurement sensitivity when operating in said table-top mode and said mid-air mode.

10. The image-display cursor-control device of claim 1 further comprising:
at least two control buttons for alternating an operational mode of said image-display cursor-control device.

11. The image-display cursor-control device of claim 1 further comprising:
at least two control buttons for alternating an operational mode for operating said image-display cursor-control device in a table-top mode and a mid-air mode.

12. The image-display cursor-control device of claim 1 further comprising:
at least two control buttons for alternating an operational mode for operating said image-display cursor-control device in a table-top mode and a mid-air mode and for alternating a measurement sensitivity when operating in said table-top mode and said mid-air mode.

13. The image-display cursor-control device of claim 1 further comprising:
a control button for alternating an operational mode for operating said image-display cursor-control device in an active mode or a standby mode.

14. The image-display cursor-control device of claim 1 further comprising:
two control buttons for alternating an operational mode for operating said image-display cursor-control device in an active mode or a standby mode.

15. The image-display cursor-control device of claim 1 further comprising:
two control buttons for continuously pressing down to move a display cursor to a designated location of an image display.

16. The image-display cursor-control device of claim 1 further comprising:
a second accelerometer for sensing tilt angle of said image-display cursor-control device along two different directions.

17. The image-display cursor-control device of claim 1 further comprising:
a signal filter and an analog to digital converter for filtering and converting an analog measurement signal generated by said accelerometer to a digital signal for inputting to a computer.

18. A data-handling and processing system comprising an image-display cursor-control device for controlling an image display cursor of an image display of said data-handling and processing system further comprising:
a pad of placing and moving said image-display cursor-control device wherein said pad comprising a curved surface.

19. The data-handling and processing system of claim 18 wherein:
said image-display cursor-control device further includes an accelerometer for sensing a tilt angle in moving along said curved surface of said pad.

20. The data-handling and processing system of claim 18 wherein:
said image-display cursor-control device further includes a container housing containing said accelerometer therein having a curved bottom surface for conveniently tilting said display cursor control device to change an elevation level of said accelerometer.
